(19) United States
(12) Patent Application Publication
(10) Pub. No.: US 2005/0132997 A1
(43) Pub. Date: Jun. 23, 2005

(54) Customization cover for engine valve covers

(76) Inventor: Marcus Vargas, Fresno, CA (US)

Correspondence Address: RICHARD A. RYAN, SUITE 110, 8497 N. MILLBROOK AVE., FRESNO, CA, 93720, US

(21) Appl. No.: 11/015,998

(22) Filed: Dec. 17, 2004

Related U.S. Application Data
(60) Provisional application No. 60/531,355, filed on Dec. 18, 2003.

(51) Int. Cl. F02F 1/00

(52) U.S. Cl. 123/195 C

(57) ABSTRACT

A customization cover for use with an engine valve cover has a main body portion configured with one or more design elements thereon to provide an improved visual effect for a vehicle engine and engine compartment. Mounting openings in the main body member are cooperatively configured to receive a connector element to place the customization cover generally above the valve cover. Preferably, side components having side design elements extend downwardly from the main body to from a generally elongated channel that is disposed above the valve cover. The connector elements can connect to the valve cover mounting points or to the ignition coil mounting points. Spacer elements, brackets and/or mounting arms on the side components can be utilized to secure the customization cover in a spaced apart relation to the valve cover to provide an enhanced three dimensional visual effect.

### CROSS-REFERENCE TO RELATED APPLICATIONS

This application claims the benefit of U.S. Provisional Application No. 60/531,355 filed Dec. 18, 2003.

### BACKGROUND OF THE INVENTION

A. Field of the Invention

The field of the present invention relates generally to valve covers and valve cover systems utilized in internal combustion engines of the type commonly used to power motor vehicles, particularly automobile, truck, boat and motorcycle engines. More specifically, this invention relates to customization covers utilized to modify the visual appearance of the engine valve cover and, generally, the engine compartment. Even more specifically, this invention relates to such customization covers that provide a three dimensional visual effect above the engine valve cover.

B. Background

As is well known in the vehicle industry, many people like to customize their vehicle, particularly automobiles and trucks, to achieve a desired visual effect that is personal to the vehicle owner. In fact, many people enjoy taking their vehicle to vehicle shows, such as hot rod shows and the like, or attending such vehicle shows where various customized vehicles are displayed. Often the persons showing their vehicles compete to win trophies or other prizes for the best customized vehicle. Efforts to customize a vehicle applies to all aspects of the vehicle, including the engine compartment. For purposes of customizing an engine compartment, it is well known that owners will replace or modify various operational components in the engine compartment to achieve a desired visual effect without necessarily modifying the operational characteristics of the engine. For instance, many vehicle owners will replace standard, factory provided components with like components that are made out of or coated with chrome or other materials or which are painted. It is also well known that many owners replace the standard, factory provided components with components that improve the performance of the vehicle.

The replacement or modification of standard factory supplied engine components includes the replacement of the engine valve covers that mount onto the engine block and cover the internal combustion engine valve assembly. As is well known, valve covers are typically made out of metal, such as steel or aluminum, and are either stamped or cast into a trough or trough-type of shape and then bolted to the engine block with a plurality of bolts, usually four to eight bolts. As also well known in the art, the typical valve cover is stamped or cast into the desired shape and provided with various visual features included on the valve cover, including names, symbols, corporate logos, ridges, indents and the like, to achieve the visual effect desired by the manufacturer. Examples of patents for valve covers having unique designs include U.S. Pat. No. Des. 324,867 to Lyndhurst, U.S. Pat. No. Des. 422,551 to Haines, U.S. Pat. No. Des. 305,767 to Tauschke, U.S. Pat. No. 252,878 to Bellino, et al. and U.S. Pat. No. Des. 305,123 to Garrett, et al. These patents, as well as the numerous non-patented valve covers known to exist, all share the common feature that they are the actual valve cover that provides the enclosure function for the operating valves of the engine.

As is well known, there are several types of valve covers commonly in use today. What is generally considered the “standard” valve cover is provided in an elongated, upside down trough configuration with a lower lip or flange that extends around the peripheral edge of the valve cover. This lower lip typically has four to eight mounting holes through which bolts are placed to engage the cylinder head portion of the engine block and mount the valve cover thereto with bolts or other connecting members or mechanisms. Typically, a sealing member is disposed between the lower lip portion and the engine block to sealably enclose the operating valves under the valve cover. An example of such an engine valve cover is set forth in U.S. Pat. No. 5,095,860 to Newell, modified for purposes of that invention. A modified valve cover, commonly referred to as a Vortec valve cover and utilized in certain vehicles manufactured by the General Motors Corporation, has a plurality of mounting holes down the center of the trough portion of the valve cover which cooperate with mounting bosses on the cylinder head portion of the engine block, typically placed between adjacent cylinders, in corresponding relationship to the mounting holes on the valve cover. Bolts or studs are used to secure the valve cover to the engine block. Examples of this type of valve cover are shown generally in U.S. Pat. No. 5,884,594 to Wiehle, U.S. Pat. No. 4,593,659 to Wells, et al. and U.S. Pat. No. 5,655,489 to Kammerer, et al. Another modified valve cover for internal combustion engines is configured with ignition coils mounted on top of the valve cover. Yet another modified valve cover for internal combustion engines is shown in U.S. Pat. No. 5,931,131 to Hackett. This patent shows an elongated valve cover assembly having a plurality of bolts or other fastening mechanisms that extend through the top of the valve cover along its peripheral edge. Other types of valve cover arrangements are also likely in use. In general, the standard and modified valve covers are configured to be removed from the engine block to allow access to the engine's valving mechanisms for repair and/or replacement of the valving components.

Customized replacements for both the standard and modified valve cover types of assemblies have been available for some time. For instance, U.S. Pat. No. 4,538,560 to Alden discloses a valve cover that has a clear “window” in the top portion of the valve cover that allows visualization of the valve system under the valve cover. The configuration shown in this patent is the standard type of valve cover, modified for purposes of the invention. It is also well known to manufacture valve covers out of different materials, such as stainless steel or carbon fiber. Manufacturing valve covers out of plastic material, such as polyamide, is discussed in U.S. Pat. No. 5,655,489 to Kammerer, et al. A number of aftermarket suppliers provide valve covers that are stamped or cast with design elements to allow the vehicle owner to obtain a different (compared to that from the original equipment manufacturer or “OEM”) look for his or her vehicle. Other supplies have valve covers that embossed with a design. In order to utilize these replacement valve covers, the user must first remove the existing valve cover and replace it with the new valve cover. In part due to the need for the new valve cover to provide the same functional aspects as the original valve cover, such as sealably enclosing the valve mechanisms, the configuration of the replacement valve cover is basically the same.

Due to the desire to improve the visual effect of a vehicle engine compartment, certain vehicle manufactures are providing covers that are configured to entirely or substantially cover the engine compartment. For instance, the Lincoln Navigator® has a cover that is configured to cover the entire engine compartment. The newer model Chevrolet Corvette® and Impala® have covers that cover the intake manifold. U.S. Pat. No. Des. 396,478 to Hubbach discloses an engine cover that is shown as being assigned to Chrysler Corporation. After market suppliers also have covers that are adapted to cover part or all of the engine block, particularly the portion between the valve covers. These covers are configured to generally provide a “clean” look to the engine compartment and are not specifically directed to the valve covers.

While the OEM and aftermarket valve covers can achieve certain visual effects, they have the limitation that the design remains very basic, that being a generally rectangular-shaped valve cover. The aforementioned patents and other prior art valve covers are only directed towards the actual valve cover itself. While this generally suffices for covering and protecting the operating valve system, it does not allow much in the way of engine customization. As a result, there is limited ability for the individual vehicle owner to customize his or her vehicle in a way that is personal or particular to him or her. This is particularly true with regard to obtaining a three dimensional effect for the engine valve cover. The presently available OEM and aftermarket valve covers have a very limited or no ability to provide a three-dimensional effect for the engine compartment, which is often desired by those who wish to customize their vehicle.

What is needed is a customization cover for engine valve covers that allows vehicle owners or operators to customize their vehicle's engine compartment without the need to replace the existing valve covers. The preferred customization cover will be relatively easy to install on or over all types of existing engine valve covers and suitable for substantially creating a three dimensional effect for the engine valve cover. The preferred customization cover for engine valve covers should be adaptable to a large variety of different valve cover and/or engine block designs and configurations in order to provide vehicle owners and operators with a choice of different “looks” for their vehicle. The preferred customization cover should also be configured to not interfere with the function of the valve cover and maintain the ability for the owner or his or her repairperson to remove the valve cover to repair or replace components of the operating valve mechanism as needed.

### SUMMARY OF THE INVENTION

The customization cover for engine valve covers of the present invention provides the benefits and solves the problems identified above. That is to say, the present invention discloses a customization cover for engine valve covers that substantially creates a three dimensional effect when utilized with all types of engine valve covers. The customization cover for engine valve covers of the present invention is adaptable for use with the existing standard and modified types of valve covers (including perimeter mount and center mount systems) and can be modified for other types of valve covers, including those not presently available. As the customization cover for engine valve covers does not require removal or replacement of the engine valve cover, although it can be used in conjunction with replacing the valve cover, it is relatively easy to install. The customization cover for engine valve covers can be configured to incorporate a wide variety of different design elements and shapes to allow significant individualization of a person's vehicle engine compartment. The customization cover for engine valve covers is configured to not interfere with the normal function of the valve cover and to allow the owner/repairperson to remove the valve cover for repair or replacement of the operating valve components.

In one general aspect of the present invention, the customization cover for engine valve covers of the present invention includes a main body having a first end, second end, top surface and bottom surface with one or more design elements on the main body generally disposed between the first end and the second end of the main body. The design elements can be a variety of different shapes and configurations. In a preferred configuration, the design elements are cut out of the main body such that they extend through the main body from the top surface to the bottom surface. Preferably, the customization cover includes one or more side component members extending generally downward from the first and/or second side of the main body. In the preferred embodiment, a side component member extends downwardly from each side of the main body to form an elongated channel that is configured generally in an inverted u-shape that is sized to fit over and substantially cover the engine's valve cover(s). The side components can be integral with the main body, such that they are made by bending the material that makes up the main body, or they can be attached to or near the main body. The side components can be configured with one or more side design elements. The customization cover includes one or more mounting openings that are configured to receive a connector element adapted to place the customization cover generally above the valve cover. In one configuration the mounting openings are disposed generally at or near the center line of the main body so the connector element can cooperatively connect to the valve cover mounting points at or near the centerline of the valve cover. In another configuration the side components each comprise a mounting arm configured with a mounting opening to securely mount the customization cover to the engine block through at the valve cover mounting points generally disposed along the periphery of the valve cover. In another configuration, a bracket is utilized to connect the customization cover to the valve cover mounting points. In yet another configuration, the customization cover mounts to one or more engine components, such as ignition coil mounting points used to mount an ignition coil to the valve cover. In any of the above configurations, the customization cover is preferably configured to be in spaced apart relation to the valve cover to provide a more improved and desired three dimensional effect.

Accordingly, the primary objective of the present invention is to provide a customization cover for engine valve covers that provides the advantages discussed above and overcomes the disadvantages and limitations associated with presently available methods and devices of customizing valve covers and vehicle engine compartments.

It is also an important objective of the present invention to provide a customization cover for engine valve covers that is easy to install and adaptable for use with all types of engine valve covers.

It is also an important objective of the present invention to provide a customization cover for engine valve covers that substantially provides a three-dimensional effect when installed over the engine valve cover.

It is also an important objective of the present invention to provide a customization cover for engine valve covers that can incorporate a wide variety of design elements to allow for a variety of personal customization and/or decorative effects according to the user's own preferences.

The above and other objectives of the present invention will be explained in greater detail by reference to the attached figures and the description of the preferred embodiment which follows. As set forth herein, the present invention resides in the novel features of form, construction, mode of operation and/or combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a perspective exploded view of a preferred embodiment of the customization cover for engine valve covers of the present invention shown configured for use with a center mounting type of valve cover;

FIG. 2 a top view of an example design for use with the customization cover of the present invention;

FIG. 3 is a top view of another example design for use with the customization cover of the present invention;

FIG. 4 is a perspective exploded view of a preferred embodiment of the customization cover of the present invention shown configured for use with a standard or peripheral mounting type valve cover;

FIG. 5 is a side view of an alternative bolt and spacer device for use with the customization cover of the present invention;

FIG. 6 is a side view of a preferred embodiment of a mounting system for the customization cover of the present invention for use with the center mounting type of valve cover;

FIG. 7 is a side view of a preferred embodiment of a mounting system for the customization cover of the present invention for use with a standard or peripheral mounting type of valve cover; and

FIG. 8 is a side view, with portions in cross section, illustrating an embodiment of the customization cover of the present invention mounted to the ignition coil above the valve cover on an internal combustion engine utilizing a coil-on-plug ignition system.

### DETAILED DESCRIPTION OF THE PREFERRED EMBODIMENTS

With reference to the figures where like elements have been given like numerical designations to facilitate the reader's understanding of the present invention, and particularly with reference to the embodiments of the customization cover for engine valve covers of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, those skilled in the art will understand that a number of variations to the components and to the configuration of those components described herein and in the accompanying figures can be made without changing the scope and function of the invention set forth herein.

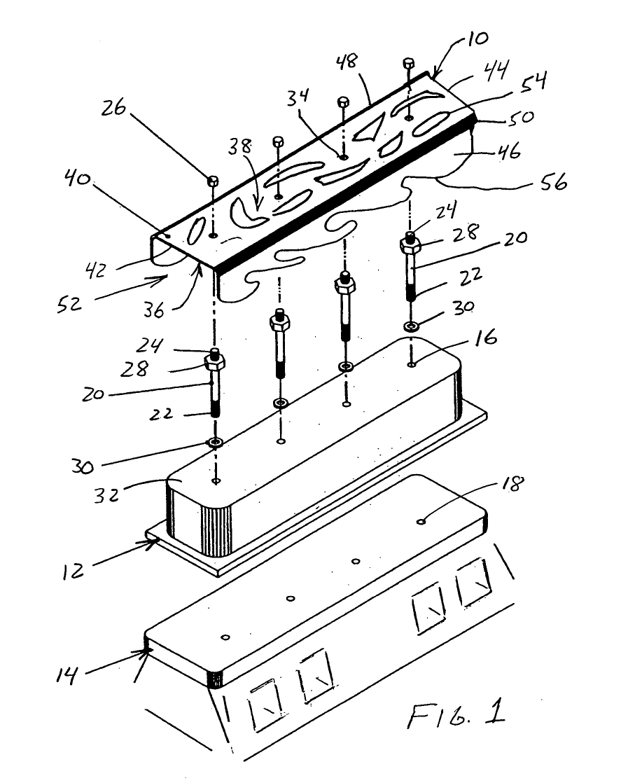

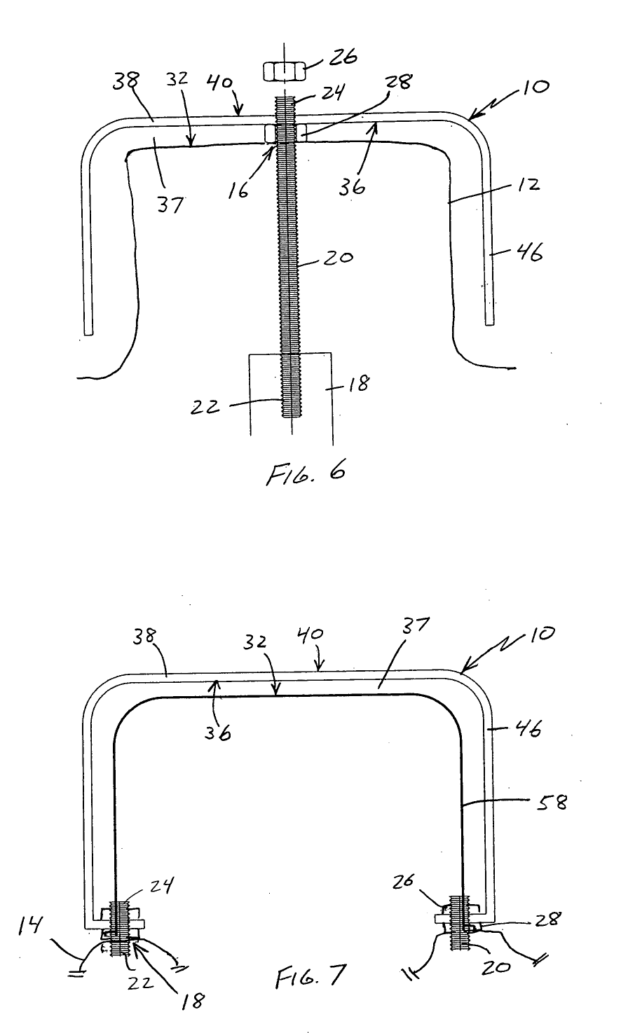

A customization cover for engine valve covers that is manufactured out of the materials and configured pursuant to the present invention is shown generally as 10 in the figures. As shown in FIG. 1, customization cover 10 is used in conjunction with a valve cover, an example of a center mounting valve cover (i.e., the Vortec-type of valve cover) is shown as 12 in FIG. 1, that is configured to be mounted on engine block 14. As known in the art, the center mounting type of valve cover 12 has a plurality of mounting holes 16 that are generally disposed along or near the longitudinal centerline of valve cover 12 and in corresponding relationship with valve cover mounting points 18, which can be bosses (best shown in FIG. 6) known in the art, located on engine block 14, generally between adjacent cylinders (not shown). In the prior art configuration, bolts or other types of connectors are inserted through mounting holes 16 and into valve cover mounting points 18 to secure valve cover 12 to engine block 14 over the engine's valve system (not shown). For the present invention, a new mounting system is provided, as set forth below, that advantageously allows use of customization cover 10 with valve cover 12.

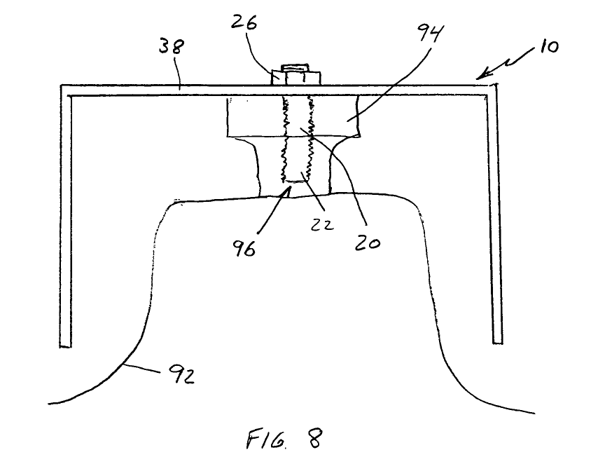

In a preferred embodiment of the present invention, shown in FIG. 1, the modified mounting system utilizes a connector element 20, such as a bolt, having a threaded first end 22 adapted to be threadably received in one of valve cover mounting points (boss) 18 and a threaded second end 24 adapted to threadably receive a upper connector 26, such as the acorn nut shown. A lower connector 28, such as the nut shown, affixed to or cooperatively engaged with connector element 20 allows the user to mount valve cover 12 to engine block 14 by inserting first end 22 of connector element 20 through mounting holes 16 into valve cover mounting points 18. If desired or necessary, washer 30 can be disposed between lower connector 28 and the top surface 32 of valve cover 12. The lower portion of connector element 20 is configured to securely mount valve cover 12 to engine block 14. When valve cover 12 is mounted to engine block 14, by lower connector 28, the threaded second end 24 of connector element 20 will be extending generally upwardly from lower connector 28 above the top surface 32 of valve cover 12. Customization cover 10, which is configured with one or more mounting openings 34 sized to receive second end 24 of connector element 20 and configured to be in corresponding relationship with one or more of mounting holes 16 and valve cover mounting points 18, is placed over valve cover 12 such that the bottom surface 36 of customizable cover 10 near mounting openings 34 substantially abuts lower connector 28. Upper connector 26 connected to second end 24 of connector element 20 will secure customization cover 10 in place above, in spaced apart relation when lower connector 28 is utilized, valve cover 12. As will be understood by those skilled in the art, the use of lower connector 28 and washer 30 will provide a space or gap 37, best shown in FIGS. 6 and 7, between customizable cover 10 and valve cover 12 such that when cover 10 is installed over valve cover 12. Although customization cover 10 can be used without gap 37, such that customization cover 10 substantially rests on or abuts top surface 32 of valve cover 12, use of lower connector 28 or other spacer elements to create gap 37 provides an improved three dimensional effect, heretofore not utilized in conjunction with valve cover 12. In an alternative embodiment, the spacer element, such as lower connector 28 and/or washer 30, can be affixed to bottom surface 36 of main body 38 of customization cover 10 to provide the desired gap 37.

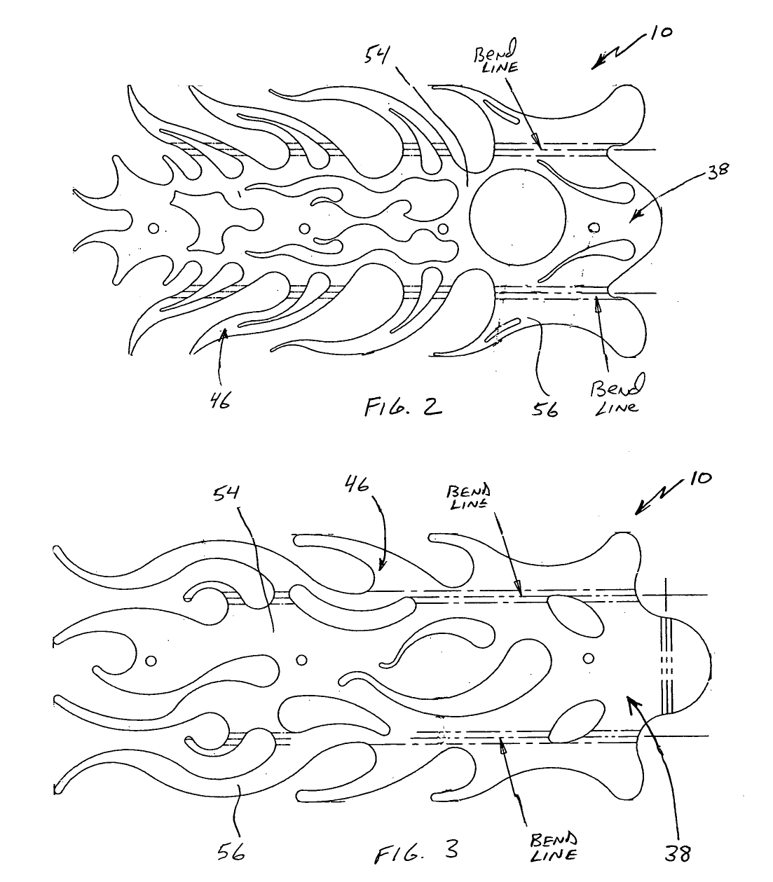

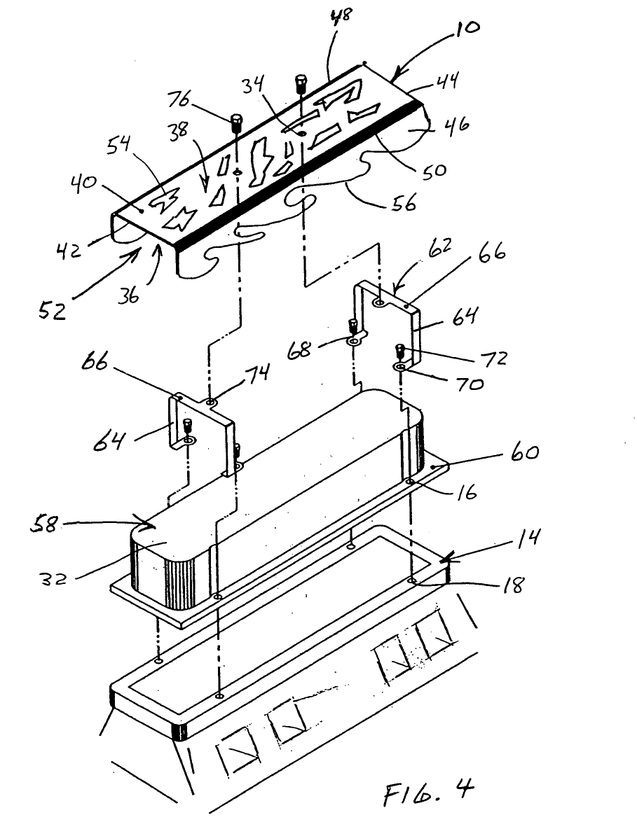

As shown in FIG. 1, a preferred embodiment of customizable cover 10 has a main body 38, with a top surface 40, generally disposed between first end 42 and second end 44, and one or more side components 46 generally extending downward from first side 48 and/or second side 50 (use at both are shown). In one embodiment of the present invention, customizable cover 10 comprises just the portion between ends 42 and 44 and sides 48 and 50 (i.e., just main body 38 with no side components 46). In the preferred embodiment, as shown, customizable cover 10 has side components 46 extending downward from both sides 48 and 50 forming a generally elongated, inverted u-shaped channel 52. Although top surface 40 of customization cover 10 can be plain or smooth, it is preferred that main body 38 be configured with one or more design elements, shown generally as 54 in FIG. 1, and side components 46. A nearly infinite variety of design elements 54 are suitable for use with customizable cover 10 of the present invention. Design elements 54 can include but are not limited to flames, circles, curves, symbols and various other graphic devices available or desired. Symbols can include corporate logos and trademarks, such as automobile or truck insignia, dollar signs, playing card symbols and the like. Examples of two possible designs are shown in FIGS. 2 and 3. As will be readily apparent to those skilled in the art, design elements 54 can be etched, carved or otherwise applied to main body 38. In the preferred embodiment, however, design elements 54 are cut out of main body 38 such that the design elements 54 go completely through main body 38 from top surface 40 to bottom surface 36. Also in the preferred embodiment, side components 46 are provided with one or more side design elements 56. As with design elements 54, the number of possible configurations for side design elements 56 is virtually infinite and can be cut out of or otherwise applied to side components 46.

Customizable cover 10 can be made out of a variety of different materials, such as stainless steel, anodized aluminum, carbon steel, carbon fiber or various other metals or non-metallic substances, alone or in various combinations. The principal requirement for such material is that it be sufficiently heat resistant to withstand the temperatures associated with valve cover 12 and be adaptable for configuration with the desired design elements. In one embodiment, customizable cover 10 is made from a No. 8 finish stainless steel member sized nine inches in width by eighteen inches in length that is water jet or laser cut to obtain the desired design (such as shown in FIGS. 2 and 3), and then placed in a press break to bend the member so as to form side components 46, resulting in a cover 10 that is generally configured with channel 52, as shown in FIGS. 1, 4, 6 and 7, that is sized to generally fit over valve cover 12. The dashed lines in FIGS. 2 and 3 represent possible places to bend the material to obtain main body 38 and side components 46. Once placed over valve cover 12, and spaced thereabove by use of connector element 20 with lower connector 28, a three dimensional effect will be created with the underlying valve cover 12.

In an alternative embodiment of the present invention, shown in FIG. 4, customizable cover is adaptable for use with the standard type of valve cover, shown as 58 having mounting holes 16 on the peripheral edge 60 thereof. Customizable cover 10 should be modified or adapted to cooperate with mounting holes 16 on the peripheral edge 60 of valve cover 58 and connect with valve cover mounting points 18 on engine block 14. One such modification is to utilize one or more brackets 62 having a pair of vertical members 64 interconnected by transverse member 66. At the lower end of vertical member 64 is a mounting portion 68 having a mounting opening 70 configured to receive bolts 72 for connecting brackets 62 to valve cover mounting points 18 on engine block 14 through mounting holes 16 of valve cover 58. Transverse member 66 has a threaded mounting opening 74 in cooperation with mounting openings 34 on customizable cover 10. Bolts 72 fix customizable cover 10 to transverse member 66 of brackets 62. With brackets 62 in place over valve cover 58, the user only needs to attach customizable cover 10 to brackets 62. In an alternative embodiment, bracket 62 can be fixedly attached to customizable cover 10. For instance, customizable cover 10 can be configured with vertical members 64 extending downward from side portions 46 such that mounting portion 68, with mounting opening 70, is placed over mounting holes 16. Bracket 62 is sized and configured to provide the desired gap 37 between customizable cover 10 and valve cover 58 to create the three dimensional effect of the present invention.

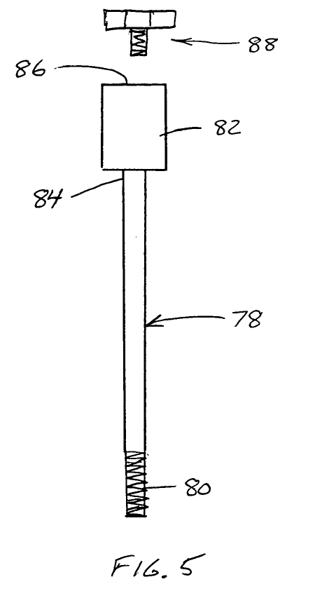

Customizable cover 10 can be used in conjunction with the OEM valve covers 12 and 58 or with an aftermarket valve covers 12 and 58, such as those made out of stainless steel and the like. As known to those skilled in the art, a variety of different devices are available to attach customizable cover 10 to valve cover 12 or valve cover 58. For instance, various adhesives or magnetic materials may be available for use, depending on the materials utilized. In the preferred embodiment, customization cover 10 is in spaced apart relation to valve cover 12 or valve cover 58. The desired spacing may be obtained by the lower connector 28 and washer 30 combination discussed above, or it may be obtained by other space providing devices. One such device for use with valve cover 12, shown in FIG. 5, is the use of a rod 78 having threads at the lower end 80 and a spacer 82 affixed (i.e., welding, adhesives, etc.) to the upper end 84, with spacer 82 having a female threaded opening at top side 86 thereof. A bolt 88 can be used to affix customizable cover 10 over valve cover 12. Spacer 82 should be sized and configured to provide gap 37 for the desired three dimensional effect. Various other configurations for a spacer element are also possible.

A preferred embodiment of utilizing customization cover 10 of the present invention with center mounting valve cover 12 is shown in FIG. 6. In this embodiment connector element 20 is “all-thread” bolt in which first end 22 threads into valve cover mounting point (boss) 18. Lower connector 28 near second end 24 of connector element 20 secures valve cover 12 to engine block 14 (not shown in this figure). Mounting opening 34 of customization cover 10 is placed over second end 24 of connector element 20 and upper connector 26 is installed to secure customization cover 10 in place in spaced apart relation to valve cover 12. Lower connector 28 abuts both top surface 32 valve cover 12 and bottom surface 36 of customization cover 10 to provide gap 37. Upper connector 26 abuts the top surface 40 of customization cover 10.

A preferred embodiment of utilizing customization cover 10 of the present invention with peripheral mounting valve cover 58 is shown in FIG. 7. In this embodiment, at least a portion of side components 46 extend generally downward to where valve cover 58 mounts to engine block 14 and a generally inwardly extending mounting arm 90 is used to mount customization cover to the valve cover mounting points 18 on engine block 14 with connector element 20. As shown, connector element 20 is “all-thread” bolt in which first end 22 threads into valve cover mounting point 18. Lower connector 28 secures valve cover 58 to engine block 14 and upper connector 26 secures customization cover 10 to valve cover 58 and, directly or indirectly, engine block 14. As shown in FIG. 7, the length of side components 46 fix the amount of gap 37 between valve cover 58 and customization cover 10.

An alternative embodiment of the customization cover 10 of the present invention is shown in FIG. 8. In this embodiment, customization cover 10 is configured for use with an engine component mounted on the valve cover, such as shown with ignition coil valve cover 92 that is of the type that is adapted for use with ignition coil 94 for coil-on-plug ignition systems. As known in the art, such ignition systems comprise an ignition coil 94 that is mounted to valve cover 92 such that one ignition coil 94 is in operational connection with a spark plug, such that each cylinder of the internal combustion engine has its own ignition coil 94. Ignition coil 94 mounts to valve cover 92 at ignition coil mounting point 96. In this embodiment of the present invention, one end of connector element 20 connects to ignition coil mounting point 96 and upper connector 26 connects to the other end of connector element 20 to secure customization cover 10 to ignition coil 94 above valve cover 92 to provide the desired three dimensional effect. If desired, a spacer element, such as lower connector 28 can be utilized to provide additional spacing between ignition coil 94 and customization cover 10.

As will be appreciated by those skilled in the art, the use of customization cover 10 of the present invention does not interfere with the normal functions of valve covers 12, 58 or 92 and customization cover 10 is easily installed and can be easily removed if the need arises to replace or repair any of the valving components associated protected by valve covers 12, 58 or 92. In addition, customization cover 10 can be made from a single, integral piece of material or it can be made from separate main body 38 and side component 46 sections that are joined as desired to provide the desired configuration for customization cover 10. Connector element 20 can be various types of bolts or bolt-like members and upper 26 and lower 28 connectors can be any of a wide variety of different types of nuts or other types of connectors.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape, and use. For instance, there are numerous components described herein that can be replaced with equivalent functioning components to accomplish the objectives of the present invention. One such modification is the use of different materials than those set forth herein and the use of integral versus connected components.

1. A customization cover for a valve cover mounted on an engine block, said customization cover comprising:
a main body having a first end, second end, top surface and bottom surface;
one or more design elements on said main body generally between said first end and said second end; and
one or more mounting openings in said customization cover, said one or more mounting openings configured to receive a connector element adapted to dispose said customization cover generally above said valve cover.

2. The customization cover according to claim 1 further comprising a side component extending generally downward from a first side and/or a second side of said main body.

3. The customization cover according to claim 2, wherein said side component is integral with said main body.

4. The customization cover according to claim 2, wherein said side component comprises one or more side design elements.

5. The customization cover according to claim 2, wherein said side component extends generally downward from each of said first side and said second side of said main body to form a generally elongated, inverted u-shaped channel configured to substantially cover said valve cover.

6. The customization cover according to claim 5, wherein each of said side component at said first side and said second side of said main body comprise a mounting arm configured to mount said customization cover to said engine block.

7. The customization cover according to claim 1, wherein said connector element is configured to connect said customization cover to said engine block at one or more valve cover mounting points.

8. The customization cover according to claim 1, wherein said connector element is configured to connect said customization cover to an engine component on said valve cover.

9. The customization cover according to claim 1, wherein said one or more design elements are cut into said top surface of said main body.

10. The customization cover according to claim 9, wherein said one or more design elements pass through said main body from said top surface to said bottom surface.

11. The customization cover according to claim 1, wherein said connector element is further adapted to maintain said customization cover in spaced apart relation to said valve cover.

12. The customization cover according to claim 11, wherein said connector element comprises a bolt member having an upper connector abutting said top surface of said main body and a lower connector abutting said bottom surface of said main body, said lower connector configured to maintain a gap between said customization cover and said valve cover.

13. The customization cover according to claim 1 further comprising a bracket interconnecting said customization cover and said engine block, said bracket configured to maintain said customization cover in spaced apart relation to said valve cover.

14. A customization cover for a valve cover mounted on an engine block, said customization cover comprising:
a main body having a first end, second end, first side, second side, top surface and bottom surface;
one or more design elements on said main body generally between said first end and said second end;
a side component extending generally downward from a first side and/or a second side of said main body; and
one or more mounting openings in said customization cover, said one or more mounting openings configured to receive a connector element adapted to connect to a valve cover mounting point and dispose said customization cover generally above said valve cover.

15. The customization cover according to claim 14, wherein said side component extends generally downward from each of said first side and said second side of said main body to form a generally elongated, inverted u-shaped channel configured to substantially cover said valve cover.

16. The customization cover according to claim 14, wherein said side component comprises a mounting arm configured to mount said customization cover to said engine block, said side component configured to maintain said customization cover in spaced apart relation above said valve cover.

17. The customization cover according to claim 14, wherein said side component comprises one or more side design elements.

18. A customization cover for a valve cover mounted on an engine block, said customization cover comprising:
a main body having a first end, second end, first side, second side, top surface and bottom surface;
one or more design elements on said main body generally between said first end and said second end;
a side component extending generally downward from a first side and/or a second side of said main body; and
one or more mounting openings in said customization cover, said one or more mounting openings configured to receive a connector element adapted to connect to an engine component on said valve cover and dispose said customization cover generally above said valve cover.

19. The customization cover according to claim 18, wherein said engine component is an ignition coil and said connector element connects said customization cover to an ignition coil mounting point on said ignition coil.

20. The customization cover according to claim 18, wherein said side component extends generally downward from each of said first side and said second side of said main body to form a generally elongated, inverted u-shaped channel configured to substantially cover said valve cover.
